(19) United States
(12) Patent Application Publication
(10) Pub. No.: US 2013/0218644 A1
(43) Pub. Date: Aug. 22, 2013

(54) DETERMINATION OF EXPERTISE AUTHORITY

(71) Applicants: Kas Kasravi, W. Bloomfield, MI (US); Ruth Bergman, Haifa (IL); Omer Barkol, Haifa (IL)

(72) Inventors: Kas Kasravi, W. Bloomfield, MI (US); Ruth Bergman, Haifa (IL); Omer Barkol, Haifa (IL)

(21) Appl. No.: 13/400,673

(22) Filed: Feb. 21, 2012

(51) Int. Cl. G06Q 10/06

(52) U.S. Cl. 705/7.39

(57) ABSTRACT

Embodiments of the present invention disclose a method and system for determination of expertise authority. According to one embodiment, data associated with a plurality of documents including expert authorship information associated with each of the plurality of documents is collected. A quality index score is determined and expertise content is analyzed for at least one document of the plurality of documents. Furthermore, an authority score of an expert or document is calculated based on the quality index score and the expertise content of at least one authored document from the plurality of documents.

### BACKGROUND

According to Metcalfe's Law, the value of a network grows exponentially with the number of the nodes in the network. This premise holds true for people networks as well as digital networks. Also, Reed's Law suggests that communities are composed of all the permutations of groups that can be formed within the overall population—a number that grows exponentially with the number of people in the population. Extracting the network value, however, can be a significant challenge. For instance, in an organization such as a medium or large corporation, much of the knowledge of the organization may be held by individuals, who may be considered subject matter experts (SMEs).

When members of an organization need to solve a problem, they seek out SMEs, typically relying on their own personal networks, or extending to their associates' networks. It is often the case that there is a relevant SME with the necessary knowledge, but that expert is outside the set of personal contacts reachable by the person seeking the knowledge. The knowledge or expertise of the SME is, therefore, not leveraged, and the optimal solution is either not achieved, or achieved at a greater cost and time. Moreover, location of the proper SMEs is often hindered by typical organizational hierarchies and time zones, limiting the contacts among the right people, who might not even know of each other's existence. Additionally, the faster pace of business and global competition requires faster development of solutions, further underscoring the need for quickly connecting the right people to address an opportunity.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of the expertise analysis system according to an example of the present invention.

FIG. 2 is a schematic diagram showing examples of nodes and edges in a conceptual competence graph for determining expert authority according to an embodiment of the invention.

FIG. 3 is a simplified flow chart of steps for constructing a conceptual competence graph according to an example of the present invention.

FIG. 4 is a simplified flow chart of steps for flow analysis in ranking experts based on authored documents and expertise according to an example of the present invention.

FIG. 5 is a simplified flow chart of steps for flow analysis in ranking documents based on expertise according to an example of the present invention.

FIG. 6 is a simplified flow chart of steps for flow analysis in ranking the expertise of an expert in accordance with an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

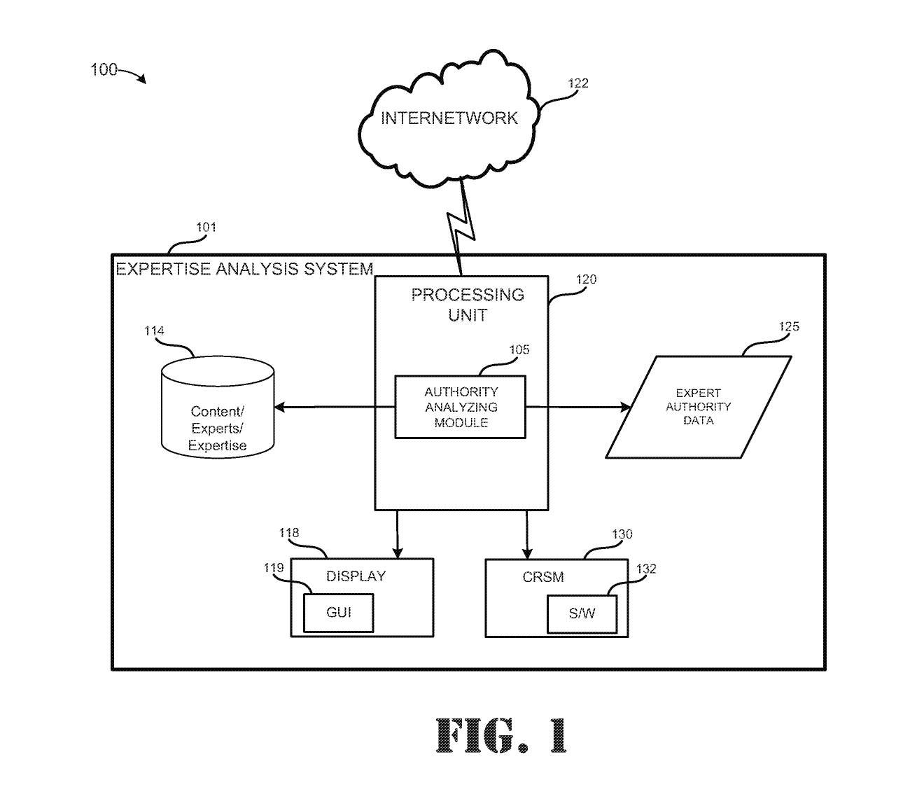

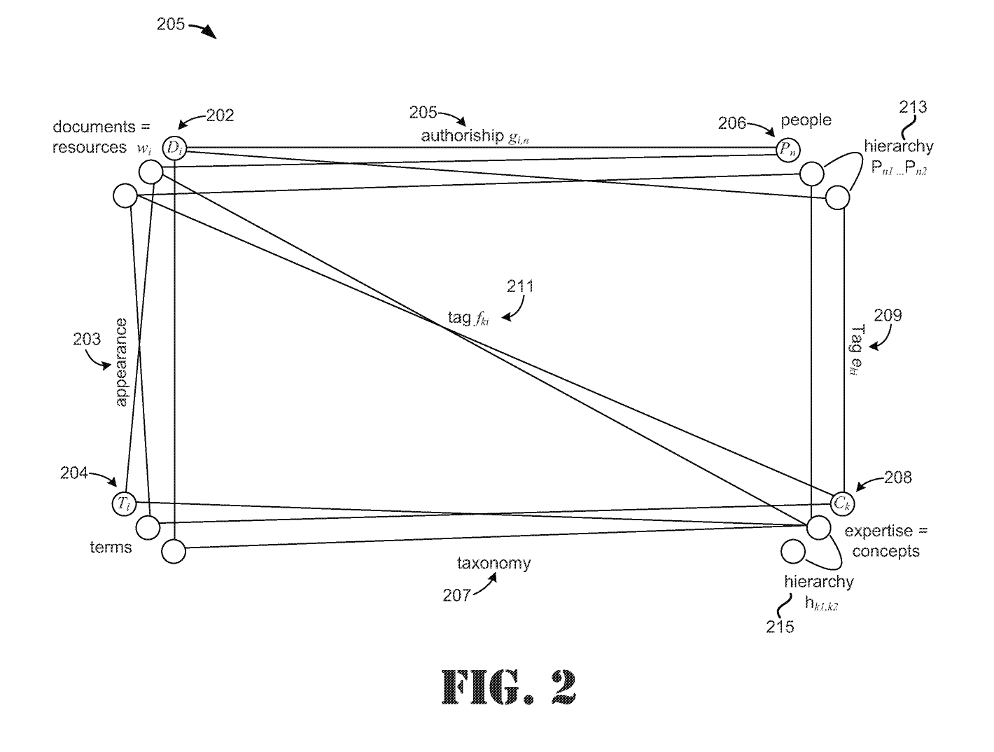

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Today, there is an increasing demand for faster time to decision in enterprises so that organizations can remain competitive by rapidly leveraging opportunities and/or responding to threats. One prior approach has been the development of applications for finding the right expert(s) for a specific request. Such applications often use linguistic analysis of content authored by experts, and infer their expertise. The outcome of such applications is typically a list of experts for a requested expertise. For example, if there is a request for “cloud security”, fifteen different experts may be recommended. In larger enterprises, however, the number of recommended experts may be of substantial size as many people may have expressed knowledge in a specific expertise. In such cases, simple identification of known experts may not be adequate. Instead, a ranking may be desired, where the requester would need to know the top experts in the specific field. Identifying such experts can help quickly find the right person to approach to address an opportunity/challenge, and hence reduce time to decision. Due to the large number of employees in enterprises, dynamic organizational structures, changing workforce, and massive content repositories, manual ranking of the authority of all known experts has proven to be a near impossible task. Therefore, there is a need in the art for an automated method for determining the authority of an expert for a specific expertise.

Examples of the present invention disclose a method for determining the authority of the individual experts. Generally, experts write about their areas of expertise in their work products such that the nature of the content can be indicative of the degree of expertise. According to one example embodiment, computing the authority of an expert in a specific area of expertise is accomplished via semantic analysis of a corpus of personally-authored documents and externally available information. Furthermore, various document parameters (e.g., citations and timeliness) as well as the attributes of the author can further contribute to an inference about the expert's authority for an expertise. More particularly, computing the authority of an expert may also be based on direct and indirect content from a mixed corpus of tagged and untagged documents. In one example, text analysis techniques are used to infer an expert's rank based on the content they have authored relative to other content. Additionally, external data may be leveraged to enhance the authority analysis of an expert.

Referring now in more detail to the drawings in which like numerals identify corresponding parts throughout the views, FIG. 1 is a simplified block diagram of the expertise analysis system according to an example of the present invention. As used herein, an “expert” is any person who possesses a specific knowledge or ability; “expertise” is the knowledge or ability possessed by the expert; and, “authority” is the degree and depth of the expertise by the expert. Here, the system 100 includes a corporate database 114, a processing unit 120 and authority analyzing module 105, a display unit 118, and a computer-readable storage medium 130. Processor unit 120 represents a central processing unit (CPU), microcontroller, microprocessor, or logic configured to execute programming instructions associated with the expertise analysis system 102. Display unit 118 represents an electronic visual configured to display images and a graphical touch user interface 119 for enabling interaction between the user and the system 100. A corporate database 114 is used as a source for information on people in the organization including the organizational hierarchy among the people, relevant expertise topics, a corpus of documents authored by experts within the organization (e.g., e-mails, blogs, presentations, reports, papers, and patents), and an expertise taxonomy (business, technical etc.), which may be hierarchical. Some of the documents may be tagged with concepts in the taxonomy, as well as some of the experts. However, tagging is not required for all the documents, nor does the tagging have to be complete, in the sense that for a specific document or experts, all the relevant concepts are tagged.

According to one example embodiment, the authority analyzing module 105 is configured to construct a graph that embodies the conceptual competence of the organization. Such a graph is referred to hereinafter as the “conceptual competence graph” or “CC graph.” Once the conceptual competence graph is constructed, analytical methods based on expertise flow are applied to the graph to analyze the expertise and to provide various functions for users to explore and rank the conceptual competence and authority of experts within the organization. In one example, the authority analyzing module 105 provides various functions to allow a user to explore the CC graph to derive various types of expertise information, such as a ranking of expertise amongst experts, a ranking of documents associated with an identified expertise, and the ranking of expertise associated with an identified expert. To that end, the authority analyzing module 105 includes analytics tools to generate the desired expertise information by analyzing the CC graph. For instance, the authority analyzing module 105 may include a flow analyzer for applying authority flow analyses to the conceptual competence graph. Furthermore, the graphical user interface 119 may be utilized to provide rankings of the expertise authority on the display device 118 for viewing by a user or requester.

Computer-readable storage medium 130 represents volatile storage (e.g. random access memory), non-volatile store (e.g. hard disk drive, read-only memory, compact disc read only memory, flash storage, etc.), or combinations thereof. Furthermore, storage medium 130 includes software 132 that is executable by processor 120 and, that when executed, causes the processor 120 to perform some or all of the functionality described herein. For example, the authority analyzing module may 105 may be implemented as executable software within the storage medium 130, or on a separate storage medium that is non-transitory. The storage medium 130 may also be used to store the input data for the authority analyzing module 105, such as the document resources and expert information, as well as the output data of the expert authority analyzing module 105, such as the expert authority data generated by the authority analyzing tools, and the visual display data for display by the display device. Alternatively, the input and output data of the authority analyzing module 105 may be received from and transmitted to a data network 122, such as the intranet of an organization or the internet, or a combination thereof.

FIG. 2 is a schematic diagram showing examples of nodes and edges in a conceptual competence graph for determining expertise authority according to an embodiment of the invention. As shown here, a portion of a conceptual competence graph may be built using four types of nodes: document nodes, term nodes, expertise or concept nodes, and people nodes. A document resource node may represent a digital document in the form of an article, a conference paper, an email, etc. (labeled i=1 . . . M with the importance of document Dᵢ given by wᵢ). The similarity between document Dᵢ to document Dⱼ may be linked via document similarity edge, which is weighted sᵢⱼ to indicate a degree of similarity between the two document resources. Furthermore, each document resource 202 may be linked by an “authorship” edge 205 to a people node, Pₙ, 208 representing a person who authored the document resource 202 (labeled n=1 . . . N, and the importance of a person Pₙ given by vₙ and weight of the authorship edge given by gᵢₙ). In this regard, a document resource may be coauthored by multiple persons and each of person/author linked to the document node. The graph further includes expertise nodes, Cₖ, representing a particular concept or knowledge focus associated with a document or person. Lastly, term nodes Tₗ represent words or terminology associated with an expertise for establishing a similarity or relevance value/rating with a particular document (i.e., terms linked with documents via appearance edge 203).

The document resources 202 (Dᵢ) may also be linked and tagged to a particular expertise 208 (Cₖ) via tag edge 211 having a weight fₖᵢ. Similarly, an expertise 208 (Cₖ) may be tagged to a person node 206 (Pₙ) by a tag edge 209 having weight eₖₙ. In addition, the taxonomy or hierarchy from expertise (concept) Cₖ₁ to expertise (concept) Cₖ₂ may be linked via edge 215 with a weight h_{k1,k2}. The CC graph may also include organizational or hierarchal employment information. For instance, a person and their manager may be connected by a “manager” edge 213. In this way, the CC graph not only identifies the association of the document resources with the people, but also the organizational relations among the people. By forming the connections among the document resources, terms, expertise, and people, examples of the present invention enable automatic determination of expertise authority with respect to individuals and documents within an organization.

Moreover, similarities among digital documents within a corpus and terminology associated with an expertise may be evaluated in number of various ways. Based on a taxonomy, which can be manually constructed or automatically derived from the documents, each document can be fully or partially associated with various expertise or concepts. One document similarity assessment method is the Vector Space Model (VSM). Under VSM, each document is represented as a vector in the space of all available words. The ith entry holds the number of times the ith word appears in the document. Another similarity evaluation method, which is a modification of the VSM method, is Latent Semantic Indexing (LSI) or Latent Semantic Analysis (LSA). LSA computes the singular vectors that correspond to the largest singular values of the matrix that includes all documents represented as columns using VSM. Then, a new representation of a document is formed by calculating its projections onto those first singular vectors. The similarity between two documents is defined as the cosine distance between the two document vectors represented as projections onto the first singular vectors.

Another embodiment of the invention utilizes a document similarity method that leverages the idea of LSI, and enhances it with semantic topics computed by a Principal Atoms Recognition In Sets (PARIS) approach. The PARIS approach handles words as sets. Given a large number of sets, PARIS detects principal sets of elements that tend to frequently appear together in the data. The PARIS approach allows non-exact repetitions of the detected patterns in the data, and allows additional elements in the input sets that are not covered by any of the detected sets. Applying PARIS to the documents in the corpus results in sets of words that tend to appear together in many documents. These sets of words could be used to represent “concepts” discussed in the documents in the given corpus.

The similarity computation may be updated whenever the document corpus evolves so as to take into account the new items. It should be noted that the similarity computation methods described above are only example approaches to evaluating the similarity (or relevance) between documents and terms in a given corpus, and the invention may be implemented using other methods of similarity computation to link document resources in the conceptual competence graph as will be appreciated by one skilled in the art.

As shown in FIG. 2, each document (D) has a weight (W) by content type, with Dᵢⱼ defining the weight of document “i” of type “j”. For instance, the content type may be assigned a predetermined weight as follows:

| Content Type | Weight |
|---|---|
| Patent | 20 |
| Technical Paper | 15 |
| Report | 10 |
| PowerPoint | 6 |
| PDF | 8 |
| Blog | 4 |

The table above simply list sample static weights for a small subset of document types, however, and examples of the present invention are not limited thereto. That is, a recursive and/or parametric function may be utilized to fine tune the weight (W) of the source document. For example, Patent A may have 5 backward and 100 forward references while Patent B includes 30 backward and 5 forward references. Here, the authority analyzing module may be configured to adjust the weight (W) of Patent A by a percentage to be more valuable than the weight given to Patent B. Similarly, the value of blogs may be modified by the number of responses received, while the value of technical papers and similar documents may be modified by their citations or other references. Thus, the weight (W) of a particular document resource (D) may be determined or adjusted by a percentage in accordance with citations or performance of the documents, the documents referenced therein, and so forth.

Additionally, each unique document (D) may include an expertise frequency count (F) such that Dᵢₖ defines the frequency of expertise “k” in document “i”. Each unique expert (E) may also include a knowledge index for each unique expertise (K), with Eₘₙ defining the knowledge index of expert “m” in expertise “n”, and computed as follows:

Eₘₙ=Σ(Dᵢⱼ*log((a*Dᵢₖ+1)̂b)) for all l, j, k, m, and n.

Coefficients “a” and “b” may vary in accordance with examples of the present invention (e.g., 10 and 1.5 respectively). Thus and in according to one example embodiment, the authority of expert Eₘ in a specific expertise Kₙ may be given by Eₘₙ as shown above.

Moreover, determination of expert authority may be augmented by leveraging external contextual data including the quality of the content, the timeliness of the content, the length of the content, and the position or job code of the author/expert. For example, the quality of the content may be determined—so as to increase the weight of the document relative to other documents—based upon the number of forward citations in a patent; the number of references to a paper; or the number of comments on a blog for example. With respect to the timeliness of the document or content, a higher relative value may be assigned to more recent content. Furthermore, the length of the content may be an indicator of the expert's depth of knowledge (assuming the content is substantive and not prolixity). Such factors may serve to influence the document-specific Dᵢⱼ value on a percentage basis for example. In another example, the employment level or position of the author/expert may be another example of expertise as the higher the job code of the author, the higher the value of all content produced by that author, particularly when the job code is relevant to the expertise. This factor may influence the overall Eₘₙ value by a relevant or absolute quantity.

Once the CC graph is constructed, information regarding expertise inside the organization can be derived using the graph. In some example embodiments of the invention, an authority flow analysis is applied to the CC graph to answer expertise questions or queries related to the expert authority within the organization. For example, the authority questions may be: “For a given expertise (concept node), what is the ranking of documents relevant to this expertise?”, “For a given expertise (concept node), what is the ranking of experts relevant to this expertise, “For a given document, what is the ranking of expertise (concept nodes) relevant to this document?”, “For a given expert, what is the ranking of expertise (concept nodes) relevant to this expert”, etc.

Moreover, several possible computations are possible for ranking experts for a given expertise Cₖ. According to one example, each computation may take into account additional inferences, which are represented by paths in the CC graph. Expert rank may be denoted as Eₙₖ values, the rank of Person Pₙ with respect to expertise Cₖ. If the expertise taxonomy is not hierarchical such that tagged documents are utilized, then the expert rank may be formulated as:

$${E}_{nk} = {\sum }_{i} {f}_{ki} {g}_{jn}$$

In such a formulation, wᵢ is incorporated into gᵢₙ (i.e., node weights are avoided). The various parameters, e.g., gⱼₙ and fₖᵢ, may fold in a variety of factors. For example, fₖᵢ may be set to the log of the frequencies for concept Eₖ in document Dᵢ, with wᵢ being incorporated into gᵢₙ so as to reduce the linear influence or biasing relating to excessive frequency of authorship in the computation of authority (e.g., bias based on a prolix report).

Another example embodiment allows ranking through similarity nodes such that untagged documents are used to infer expertise and compute rank. For example, given an expertise taxonomy that is not hierarchical, the expert rank Eₙₖ may be formulated as:

$${E}_{nk} = {\sum }_{i} {\sum }_{j : {f}_{kj} = 0} {f}_{ki} {s}_{ij} {g}_{jn}$$

Here, wᵢ is incorporated into fₖᵢ and wⱼ is incorporated into gⱼₙ so that when relevance flows from one document to another, the importance of each document affects the overall expert ranking.

In yet another example embodiment, the authority analyzing module could set up flow formulation for a single matrix over all the nodes of the graph, with all the edges included as entries in the matrix. Furthermore, setting 0 on the diagonals would correspond to self-loops for every node. Steps of the flow algorithm may then correspond to multiplications of the matrix. One step of the flow, which includes paths of length 1 in the graph, may correspond to a single multiplication, with two steps corresponding to two multiplications, etc. The sum of these matrices would then give the required expertise in the appropriate entry.

Still further, flow to rank expertise may still be accomplished when the expertise taxonomy is hierarchical. In this example, relevance from the query expertise node Cₖ is first flowed to all expertise nodes below it in the hierarchy, using the weights h_{k1,k2} for example. Accordingly, weights C_{k′} are produced for each expertise node C_{k′}. The rank for a specific Pₙ, which is an expert's expertise in Cₖ, is computed by flowing from every expertise node and summing over these paths:

$${E}_{nk} = {\sum }_{{k}_{i}} {\sum }_{i} {\sum }_{j : {f}_{kj} = 0} {c}_{{k}^{′}} {f}_{{k}^{′} i} {s}_{ij} {g}_{jn}$$

In addition, if an expert is tagged explicitly, the direct flow may be added from any expertise node C_{k′} to the person Pₙ as follows:

$${E}_{nk} = {\sum }_{{k}_{i}} ( {e}_{{n}^{′} {k}^{′}} + {\sum }_{i} {\sum }_{j : {f}_{kj} = 0} {c}_{{k}^{′}} {f}_{{k}^{′} i} {s}_{ij} {g}_{jn} )$$

In some application it may desirable to flow expertise through the expert hierarchy. In hierarchies such as the hierarchy formed by advisor/advisee relations, inheritance of expertise is a reasonable assumption. In such a scenario, interest may be flowed through the people hierarchy using a dual procedure to the formula used for the expertise hierarchy. More particularly, weights p_{n′} may be pre-computed for each person P_{n′} based on the people hierarchy from Pₙ, and in the ranking computation, summed over all the paths containing all people P_{n′}.

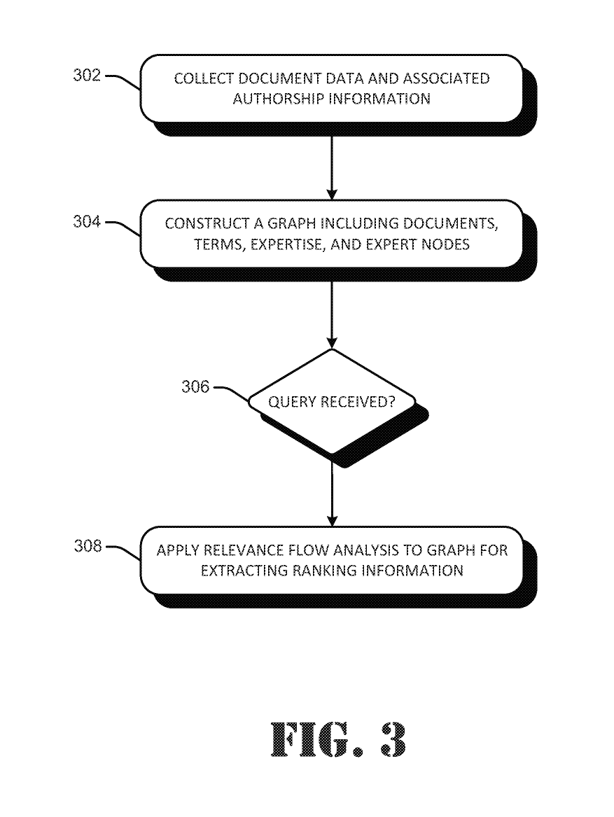

FIG. 3 is a simplified flow chart of steps for constructing an expertise graph according to an example of the present invention. In step 302, a corpus of documents (document data) and authorship information (expert/people) related to said documents are collected by the system. In one example, the referenced expertise may be tagged and associated with the experts (i.e., prior work). Next, in step 304, a conceptual competence graph is constructed by the authority analyzing module for example to include the document nodes, term nodes, expertise nodes, and people nodes. When a query is received in step 306, a flow analysis is applied to the conceptual competence graph such that a “focus node” or a set of “focus nodes” (area of user interest) propagates along a path or paths to a “query node” or set of “query nodes” (i.e., authority/ranking information). For example, flow may propagate from the expertise node (i.e., focus node) through author edges and towards the term nodes, through the similarity and appearance edges to other document resources, and then through authorship edges to the people nodes, which in this context may represent the “query nodes” (e.g., locate proper experts).

As mentioned above with respect to FIG. 2, each node or each edge may be assigned a certain weight, and the flow from one node to others can take into account the weights. The functional dependence on the weight of each edge or node passed in the interest flow process can be selected depending on the type of edge or node, and may be adjusted based on the data being analyzed. For instance, when the interest flows through an edge, the weight of the edge may function as a simple multiplier to the interest flow. Alternatively, as an example, the edge weight to the N^{th} power may be used as a multiplier. This tends to have the effect of magnifying the differences in the weights of edges, and may be useful for differentiating the edge connections when their weights are similar, thus leading to a more meaningful ranking determination. Other types of functional dependence may be chosen based on the nature of the edge and other factors.

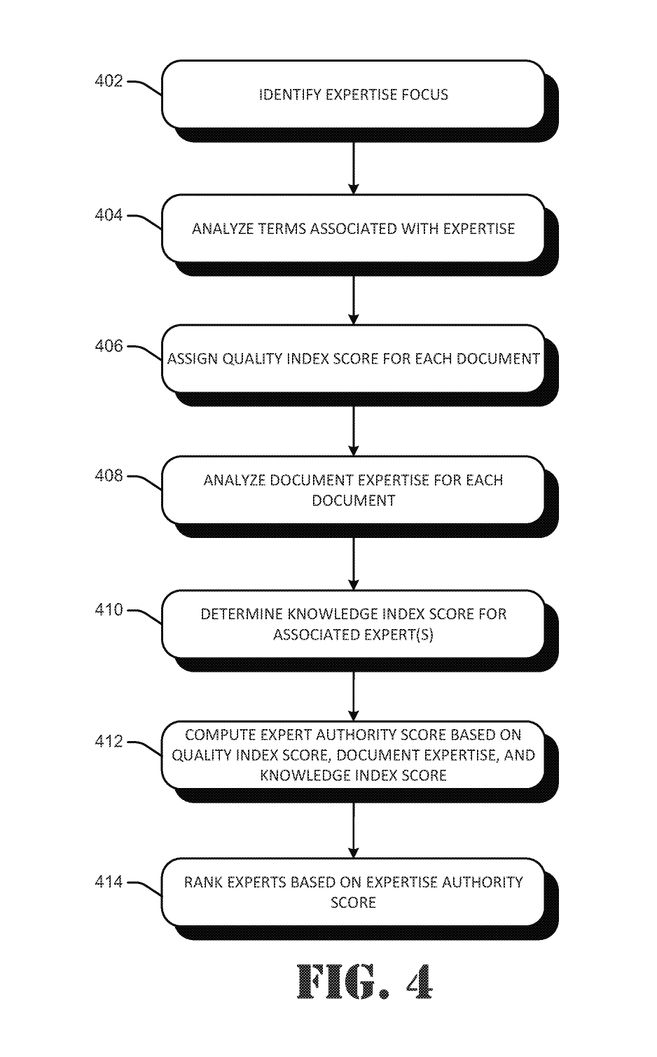

FIG. 4 is a simplified flow chart of steps for flow analysis in ranking experts based on authored documents and expertise according to an example of the present invention. In step 402, an expertise focus is identified by an operating user. By way of example, the requested query may be for experts or people in the organization having an expertise in “artificial intelligence” (i.e., focus node) for example. Next, terms associated with the identified expertise are analyzed by the processing unit or authority analyzing module in step 404. Thereafter, in step 406 semantic analysis (keywords, related words, frequency, etc.) is performed on the content of the corpus of documents based on terms related to the expertise so as to assign a quality index for each document. More particularly, analysis of the parameters of the corpus of documents (type of document, nature of document, length of document, citations, date of publication, etc.) serve to contribute to the quality index for each document resource. And as explained above, each document may be assigned a predetermined weight based on type or nature the document (e.g., a patent may have a higher weight than a report, and an e-mail may have a lower weight than a report) in computation of the quality index score. Next, in step 408, the expertise of each document (tagged or untagged) is analyzed as discussed above. Moreover, within each document, each expertise may be given a weight based on the frequency or position of the expertise within the document.

In step 410, a knowledge index score for the associated experts is determined. According to one example, each expert may also be assigned a weight based on his/her position or role within an enterprise and/or the level of expertise for establishing the knowledge index of a particular expert. That is, different types of content, in general, may imply different levels of expertise and the frequency of references to expertise may further contribute to the level of authority of the expert. For example, an inventor in a patent for technology X is more likely to have a higher authority and higher weighted index score than the author of a single blog about technology X. By the same measure, an expert who has referenced a specific expertise only a few times is less likely to be as authoritative and thus a lower knowledge index score than another expert who has been profusely writing about the expertise over an extended period of time. Thus, the authority score for each expert for a particular expertise may then be computed in step 414 based on the quality index score of the authored documents, document expertise and weight thereof, and the knowledge index score of the individual expert. Lastly, in step 414 the authority analyzing module returns a ranking of experts with respect to the selected expertise based on authority score of identified experts (i.e. highest to lowest).

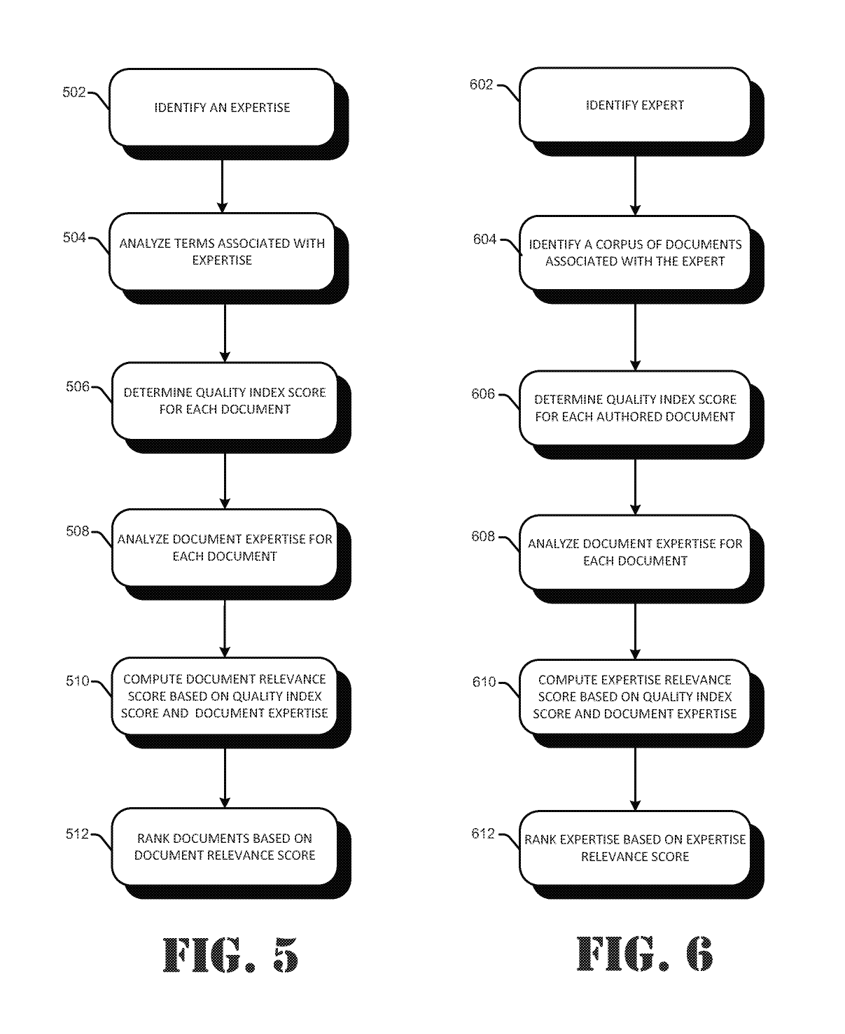

FIG. 5 is a simplified flow chart of steps for flow analysis in ranking documents based on expertise according to an example of the present invention. In step 502, an expertise focus is identified by an operating user. Here, the query may be for documents (i.e., query nodes) having an expertise relating to “artificial intelligence” for example. Next, terms associated with the identified expertise are analyzed by the processing unit or authority analyzing module in step 504. As in the previous example, semantic analysis (keywords, related words, frequency, etc.) is performed on the content of the corpus of documents based on terms related to the expertise so as to assign a quality index for each document in step 506. In step 508, the expertise of each document is analyzed (tagged or untagged) as discussed above with respect to FIG. 2. Furthermore, a document relevance score is computed in step 510 based upon the quality index score of the individual document and the expertise contained therein. For example, a recent patent document having a high frequency of terms relating to “artificial intelligence” will receive a higher document relevance score than a two-year old presentation which mentions the term “machine learning” only a handful of times. In step 512, the authority analyzing module returns a ranking of relevant document resources affiliated with the expertise and sorted by the document relevance score.

FIG. 6 is a simplified flow chart of steps for flow analysis in ranking the expertise of an expert in accordance with an example of the present invention. In step 602, an expert focus node is identified by an operating user. In the present example, the query may be for a ranking of expertise associated with the expert. The expert analyzing system proceeds to identify at least one document authored by the selected expert in step 604. Thereafter, in step 606 the system performs semantic analysis (keywords, related words, frequency, etc.) on the content of the identified document(s) so as identify expertise terms and assign a quality index for each document. In step 608, the expertise of each document is analyzed based on the terms within the document(s). Based upon the quality index score of each document and the expertise contained therein, an expertise relevancy score is computed in step 610. In step 612, the authority analyzing module returns a ranking of authority expertise of an author sorted by the expertise relevance score. For example, an expert may have written a few older blogs concerning “Patent Case Law”, several patents directed towards “Nanotechnology”, and recently submitted a technical paper on “Robotics”. The configuration in accordance with examples of the present invention would be able to automatically locate the documents associated with selected expert and return a ranking of relevant expertise such as “1. Nanotechnology, 2. Robotics, and 3. Patent Case Law.”

Embodiments of the present invention provide a method and system for automated determination of expertise authority. Many advantages are afforded by configuration of the present examples. For instance, the method and system described herein is capable of ranking of experts for a specific expertise without manual labor. Moreover, rapid identification of the right expert(s) who can most effectively respond to an opportunity or a challenge serves to promote collaboration within an enterprise while also effectively reducing time to decision—a critical aspect of large enterprises. Still further, competitive advantage and cost reduction are maximized and customer satisfaction is increased by leveraging the best available resources in a timely manner.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A computer-implemented method for determining expertise authority in an organization, the method comprising:
collecting, via a system having a processor, data associated with a plurality of documents including expert authorship information associated with each of the plurality of documents;
assigning, via the system, a quality index score for at least one document of the plurality of documents;
analyzing, via the system, expertise content for at least one document of the plurality of documents; and
calculating, via the system, an authority score of an expert or document based on the quality index score and the expertise content of at least one authored document from the plurality of documents.

2. The method of claim 1, wherein the step of calculating an authority score further comprises:
creating, by a system having a processor, a graph including:
a plurality of expert nodes representing people in the organization; and
a plurality of document nodes representing document resources authored by said people,
a plurality of expertise nodes representing concepts of interest;
a plurality of term nodes representing concept terminology associated with the expertise concepts, and
wherein the graph further comprise a plurality of edges, including author edges linking the document resources to the persons, and term appearance edges linking document resources having a similarity value indicative of similarity between the concept terminology and expertise concepts; and
computing, by the system, a relevance value between a focus node in the graph and a set of query nodes in the graph.

3. The method of claim 2, where the step of computing the relevance value includes applying a flow analysis along a path in the graph connecting the expertise nodes, term nodes, document nodes, and expert nodes.

4. The method of claim 3, wherein the step of assigning a quality index score for each of the plurality of documents further comprises:
examining a network for external references to the at least one document; and
increasing the quality index score based on a factor or quantity of external references to said document.

5. The method of claim 3, wherein the step of assigning a quality index score for each of the plurality of documents further comprises:
analyzing the timeliness of the document such that more recent documents are assigned a higher value.

6. The method of claim 5, further comprising:
determining a knowledge index score of the author based on an employment level of the author and a history of authored content; and
adjusting the authority score of the expert based on the knowledge index score.

7. The method of claim 3, wherein the focus node is an expertise, and the query nodes are a set of experts.

8. The method of claim 3, wherein the focus node is an expertise, and the query nodes are a set of documents.

9. The method of claim 3, wherein a plurality of experts are ranked in order by the determined authority score and displayed to an operating user.

10. A non-transitory computer readable storage medium having stored executable instructions, that when executed by a processor, causes the expertise authority determination system to:
retrieve content information related to a corpus of documents and authorship thereof;
determine a quality index score for each document within the corpus of documents based on a category of the document;
extract concept information from each document within the corpus of documents based on expertise terminology data; and
calculate an authority score of an author based on the quality index score and the concept information of at least one authored document from the corpus of documents.

11. The non-transitory computer readable medium of claim 10, wherein the computer-executable instructions further cause the system to:
create a conceptual competence graph including a plurality of expert nodes representing people in the organization, a plurality of document nodes representing document resources authored by said people, a plurality of expertise nodes representing concepts of interest, a plurality of term nodes representing concept terminology associated with the expertise concepts, wherein the graph further comprise a plurality of edges, including author edges linking the document resources to the persons, and term appearance edges linking document resources having a similarity value indicative of similarity between the concept terminology and expertise concepts; and
apply a relevance flow analysis along a path in the graph connecting a focus node and a set of query nodes to compute an authority value indicating relevance of the query nodes to the focus node.

12. The non-transitory computer readable medium as in claim 12, wherein the computer-executable instructions further cause the system to apply a flow analysis along a path in the graph connecting the expertise nodes, term nodes, document nodes, and expert nodes.

13. The non-transitory computer readable medium as in claim 10, wherein the step of assigning a quality index score for each document within the corpus includes computer-executable instructions that further cause the system to:
examine a network for external references to the at least one document; and
increase the quality index score based on a factor or quantity of external references to said document.

14. The non-transitory computer readable medium as in claim 10, wherein the step of assigning a quality index score for each document within the corpus includes computer-executable instructions that further cause the system to:
analyze the timeliness of the document such that more recent documents are assigned a higher value.

15. The non-transitory computer readable medium as in claim 10, wherein the step of assigning a quality index score for each document within the corpus includes computer-executable instructions that further cause the system to:
determine the employment level of the author such that the quality index score is adjusted based on the employment level of the author.

16. The non-transitory computer readable medium as in claim 11, wherein the focus node is an expertise and the query nodes are relevant experts.

17. The non-transitory computer readable medium as in claim 11, wherein the focus node is an expertise and the query node are relevant documents.

18. An expertise authority determination system comprising:
a processor;
an authority analyzing module having computer-executable instructions on a non-transitory computer-readable medium, the computer-executable instructions when executed by the processor perform steps of:
collect data associated with a plurality of documents including expert authorship information associated with each of the plurality of documents;
assign a quality index score for each of the plurality of documents;
analyze expertise content for each of the plurality of documents; and
calculate an authority score of an expert author based on the quality index score and the expertise content of at least one authored document from the plurality of documents.

19. The system of claim 18, wherein the authority analyzing module is furthered configured to:
construct a conceptual competence graph including:
a plurality of expert nodes representing people in the organization,
a plurality of document nodes representing document resources authored by said people,
a plurality of expertise nodes representing concepts of interest, and
a plurality of term nodes representing concept terminology associated with the expertise concepts,
wherein the graph further comprise a plurality of edges, including author edges linking the document resources to the persons, and term appearance edges linking document resources having a similarity value indicative of similarity between the concept terminology and expertise concepts; and
apply a relevance flow analysis along a path in the graph connecting a focus node and a query node to compute an authority value indicating relevance of the query node to the focus node.

20. The system of claim 18, further comprising:
a display coupled to the system for displaying a plurality of experts ranked in order by the determined authority score.
